(19) United States
(12) Patent Application Publication
(10) Pub. No.: US 2016/0173200 A1
(43) Pub. Date: Jun. 16, 2016

(54) MULTI-CHANNEL VISIBLE LIGHT COMMUNICATIONS SYSTEMS AND METHODS

(71) Applicant: AKT IP Ventures LLC, Washington, DC (US)

(72) Inventor: Nicolas Chaillan, Washington, DC (US)

(21) Appl. No.: 14/610,111

(22) Filed: Jan. 30, 2015

Related U.S. Application Data
(60) Provisional application No. 62/092,366, filed on Dec. 16, 2014.

(51) Int. Cl. H04B 10/112; H04B 10/00; H04B 10/85; H04B 10/114

(52) U.S. Cl. CPC H04B 10/1129; H04B 10/1143; H04B 10/22; H04B 10/85

(57) ABSTRACT

Systems and methods for broadcasting messages, such as ads, within a venue, such as a stadium or other lighted site, using VLC Multi Channel protocols are disclosed. Embodiments include RF-transmitting mobile devices with VLC detectors attached, VLC Bulbs, and a VLC stadium controller. Various embodiments of the systems and methods read a database for next event and associated message; find appropriate users to which to send the message; extract the message from the database; send the message to VLC bulb through the broadcast system in the site; receive RF responses from users (e.g., via Wi-Fi, 3G, 4G, LTE); and save the responses to a database.

### CROSS REFERENCE TO RELATED APPLICATIONS

This application claims the benefit of U.S. Provisional Application No. 62/092,366 filed on 16 Dec. 2014, which is hereby incorporated by reference in its entirety.

### BACKGROUND

The present disclosure relates generally to Visible Light Communications (VLC), and more particularly, to a hybrid VLC down, non-VLC up communications path with secure, one-to-one channel communication.

Visible Light Communications (VLC) is a data communication medium using visible light between 400 and 800 THz (375-780 nm). VLC technology uses fluorescent lamps to transmit signals at 10 kbit/s or LEDs to transmit signals at up to 500 Mbit/s. Specially designed electronic devices generally containing a photodiode receive signals from light sources, although in some cases a cell phone camera or a digital camera will be sufficient. The image sensor in these devices is an array of photodiodes (pixels) and in some applications their use may be preferred over a single photodiode. Such a sensor may provide either multi-channel communication (down to 1 pixel=1 channel) or a spatial awareness of multiple light sources. Because VLC data communications require a line-of-sight communication path, VLC data communications are typically a more secure type of communication as compared to traditional wireless communications.

Although VLC systems can be used as a communications medium for transmitting data via line of sight to one or multiple users, VLC systems present challenges as the technology is primarily a one-way communications medium that has great difficulty receiving acknowledgment that information sent to a user was actually received.

In one particular example, conventional advertising in large, lighted sites or venues typically relies on signage to attract buyers to a location within the site or venue (e.g., a stadium) and vendors moving around within the stadium to sell goods. Recently, some stadiums have implemented customer texting to stadium vendors so that items can be delivered to the customers. However, the areas within many stadiums that are enabled for these types of sales methods are typically quite small due to bandwidth limitations. Therefore, what is needed is a better or more efficient way of connecting stadium event attendees with available vendors. Similarly, the managers of any type of lighted site, such as an office building, a train station, an airport, a museum, a theater, etc. also need better ways to communicate with the people at the site.

### SUMMARY

Systems and methods for broadcasting using VLC Multi-Channel are disclosed. In various embodiments, the systems and methods include means and components for performing operations and functions for communicating with a mobile device associated with a user in a lighted site. In various embodiments, the operations and functions may include selecting a message for broadcasting; selecting the user as being appropriate to receive the message; broadcasting the message with information identifying the user, wherein the computing device controls light sources in the lighted site containing the mobile device associated with the user to perform the broadcasting; receiving a response to the message from the mobile device associated with the user, wherein the response is transmitted via a radio frequency signal from the mobile device; and storing the response in association with the user.

In various embodiments, the broadcast system operates within a system architecture that includes components that dynamically interact with each other through network connections. In these embodiments, the broadcast system includes one or more components, such as, for example, a VLC stadium controller, a hardwired connection, VLC bulbs, a VLC detector, a mobile device, a user, a communication network, links, an advertiser network, a third party network, and other networks. A mobile device further includes one or more sub-components, such as COMM (e.g. a radio or other wireless communication component), VLC software (Native), code, a profile DB, a mobile device VLC App, an OS, and OS settings. A VLC stadium controller further includes one or more sub-components such as a VLC database, VLC stadium software, an Application Programming Interface Controller (API controller), a VLC App, and VLC software. Further to these embodiments, the system architecture includes one or more user interfaces that allow the user to interact with the broadcast system.

In exemplary operation, a user attaches a VLC detector to a mobile device and COMM is activated in the mobile device. Examples of COMM include Wi-Fi, 3G, 4G, LTE, and the like. The user employs the mobile device to connect to the VLC stadium controller through the communication network and downloads VLC software and a VLC App. The VLC software and the VLC App are installed on the mobile device. The VLC software and VLC App then begin operating and the VLC software monitors and communicates with the VLC detector. The VLC Software operates on the mobile device and the VLC App allows a user to interact with the VLC stadium controller. A profile is then loaded and the user provides personal data such as, name, emails, phone number, and the like. The VLC App also generates an encryption code. The user sends the profile and the encryption code via the communication network to the VLC Stadium Controller, which logs into the VLC stadium software. The VLC stadium software queries the VLC database, specifically the user profile database, to verify that the person who downloaded the VLC App is available at the mobile device. The VLC stadium controller transmits an encryption code or security code with a message (or without a message) back to the specific user associated with mobile device via light emitted by a VLC bulb. The VLC detector attached to mobile device detects the VLC bulb transmission and the VLC software (Native) matches the security codes to the profile. The user receives the message that may or may not include ads, coupons, information, and the like, such as general information about the sport stadium and/or event hall. The user may or may not respond to a message that is received. If the user responds, an automatic security code generator within the VLC App generates a new code which is sent back to the VLC stadium controller using COMM (e.g., Wi-Fi, 3G, 4G, LTE, and the like) with the response message and starts a constant communication loop.

According to some embodiments, a method for broadcasting data using VLC multi-channel protocols includes a plurality of steps performed by a processor. The steps include: downloading and installing a VLC app and VLC software; creating user profiles and generating security codes; executing an overall communication loop method; allowing networks to load messages and data to the VLC stadium controller; and extracting messages or data from the VLC database to inject into the overall communications loop method. In these embodiments, the overall communications loop method includes transmitting a message to a mobile device from a VLC stadium controller using VLC multi-channel protocols and receiving an acknowledgement message from the mobile device using standard wireless communication methods (e.g., Wi-Fi, 3G, 4G, LTE, and the like).

According to some embodiments, a method for an overall communications loop method using VLC multi-channel protocols includes a plurality of steps performed by a processor. The steps include: a user providing a profile and a security code for that specific user; the user sending the profile and the security code and a message to the VLC stadium controller and to the VLC database via the communication path; receiving a profile and a security code at the VLC stadium controller and sending message back to the specific user via one or more VLC bulbs; the user of the mobile device detecting the message from at least one VLC bulb and matching the security code to the profile; the user receiving the message at the user interface of the VLC app; the VLC app generating a new security code; and the user responding with a message back to the VLC stadium controller through the COMM (e.g., Wi-Fi, 3G, 4G, LTE, and the like) and via the communication network.

According to some embodiments, a method for managing the VLC database within the broadcast system includes a plurality of steps performed by a processor. The steps include: reading a database for the next event; finding appropriate users; extracting messages from the database; sending the messages to the VLC bulb through the broadcast system for transmission via light; receiving radio-frequency responses from users through the broadcast system (e.g., Wi-Fi, 3G, 4G, LTE, and the like); and saving the responses to the VLC database. In one or more embodiments, the methods and system described above may be deployed in high density wireless locations, such as, for example movie theaters, museums, stadiums, train stations, trains, airports, airplanes, supermarkets, shopping malls, schools, and the like. In other embodiments, the methods and systems described above, using VLC multi-channel protocols, may increase security of a transmission (e.g., combatting man in the middle attacks) due to line-of-sight propagation of light waves and the inability of light waves to penetrate walls and other opaque materials.

### BRIEF DESCRIPTION OF THE FIGURES

Non-limiting embodiments of the present invention are described by way of example with reference to the accompanying figures which are schematic and are not intended to be drawn to scale. Unless indicated as representing the background art, the figures represent aspects of the invention.

FIG. 1 is a block diagram illustrating a broadcast system using VLC Multi channel protocol, according to an exemplary embodiment;

FIG. 2 is a block diagram illustrating an exemplary computing device in which one or more embodiments of the present disclosure may operate, according to an embodiment;

FIG. 3 is a block diagram illustrating a portion of the broadcast system pertaining to the API controller within the VLC stadium controller, according to an embodiment;

FIG. 4 is a block diagram illustrating a portion of the broadcast system pertaining to the VLC Database within the VLC stadium controller, according to an embodiment;

FIG. 5 is an exemplary illustration of a user interface of the VLC stadium controller API, according to an embodiment;

FIG. 6 is an exemplary illustration of a user interface of the VLC app installed on the mobile device, according to an embodiment;

FIG. 7 is an exemplary illustration of a user interface of the OS settings of the mobile device, according to an embodiment;

FIG. 8 is a flowchart of a method for a broadcasting data using VLC Multi channel protocol, according to an embodiment;

FIG. 9 is a flowchart of a method for an overall communications loop within the broadcast system, according to an embodiment;

FIG. 10 is a flowchart describing a method for managing the VLC database within the broadcast system, according to an embodiment;

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

### System Components and Architecture

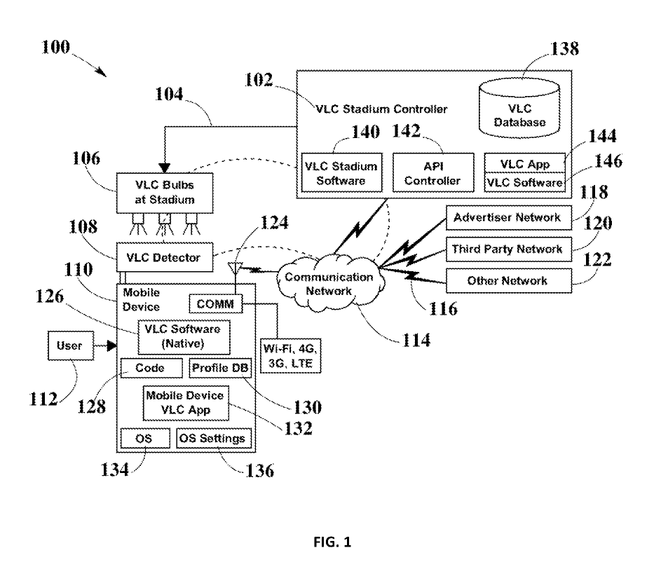

FIG. 1 is a block diagram illustrating a Broadcast System 100 using VLC Multi-channel. In some embodiments, Broadcast System 100 is used in a lighted site or venue such as a sports stadium or an event hall. For example, information regarding sports, events, or ads is sent to multiple users via VLC Multi-channel where multiple users may be able to respond to that information.

According to an embodiment, Broadcast System 100 includes a VLC Stadium Controller 102, a Hardwired Connection 104, a light source such as VLC Bulbs 106, a VLC Detector 108, a Mobile Device 110, a User 112, a Communication Network 114, links 116, an Advertiser Network 118, a Third Party Network 120, and an Other Network 122. Mobile Device 110 (e.g., a smartphone or a tablet computer) further includes one or more sub-components, such as COMM 124, VLC Software (Native) 126, Code 128, a Profile DB 130, a Mobile Device VLC App 132, an OS 134, and OS Settings 136. The VLC Stadium Controller 102 further includes a VLC Database 138, VLC Stadium Software 140, an Application Programming Interface Controller (API Controller 142), a VLC App 144, and VLC Software 146. It should be understood that Broadcast System 100 and VLC Stadium Controller 102 can include fewer components, more components, or different components depending on desired goals.

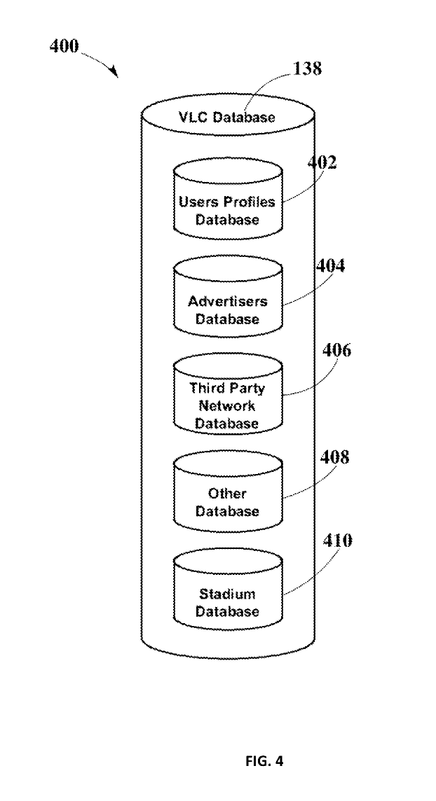

According to an embodiment, VLC Database 138 further includes one or more databases such as, one or more User Profiles Databases, one or more Advertisers Databases, one or more 3rd Party Network Databases, one or more Other Databases, and one or more Stadium Databases. The databases contained/operating within VLC Database 138 are further described in FIG. 4.

In FIG. 1, VLC Stadium Controller 102 is operatively coupled to and in bi-directional communication with one or more Mobile Devices 110, one or more Advertiser Networks 118, one or more Third Party Networks 120, and one or more Other Networks 122. VLC Stadium Controller 102 is further operatively coupled to and in uni-directional communication with one or more VLC Bulbs 106 and one or more VLC Detector 108. Each of the sub-components within Mobile Device 110 and VLC Stadium Controller 102 may be a set of computer instructions executed by central processing units that run computer executable program instructions or related algorithms. Each central processing unit may be a component of one or more computing devices such as a server, a single computer, or multiple computers in a distributed configuration.

Each of the different components of Broadcast System 100 may be implemented in any type of suitable processor-controlled device that receives, processes, and/or transmits digital data, configured as further described below. Examples of suitable processor-controlled devices include smartphones, desktop computers, laptop computers, servers, tablets, PDAs, and specialized computing platforms for generating and distributing messages to multi-users in a secure network. Examples of Mobile Devices 110 may include smartphones, desktop computers, laptop computers, tablets, and PDAs, among others.

In one embodiment, VLC Database 138 within VLC Stadium Controller 102 is a plurality of relational databases that provide functions of fetching, indexing, and storing data. Examples of data are information related to the user, information produced by advertisers to be transmitted to the users (e.g., ads, coupons, etc.), and general information about events that happen within the stadium and/or event halls. VLC Database 138 may be implemented through known in the art database management systems (DBMS), such as, MySQL, PostgreSQL, SQLite, Microsoft SQL Server, Microsoft Access, Oracle, SAP, dBASE, FoxPro, IBM DB2, LibreOffice Base, FileMaker Pro, and/or any other type of database that may organize collections of data.

In one or more embodiments, VLC Stadium Controller 102 is a server or network that is physically located at the stadium and/or event hall and is hardwired 104 to VLC Bulbs 106. In these embodiments, VLC Stadium Controller 102 interacts with one or more mobile devices 110 through VLC detectors 108, and through one or more networks, via communication network 114 (e.g., via a radio frequency wireless network), for the purpose of broadcasting advertisements or messages and responses. Examples of VLC Bulbs 106 include physical light bulbs and light emitting diodes that are used for transmitting data via light to VLC Detectors 108 on Mobile Device 110. Other types of light sources may also be used in some embodiments. Example of VLC detectors 108 include generic VLC detectors such as a dongle that attaches to the earpiece or other connector of Mobile Device 110 and receives VLC signals. In other embodiments, VLC detectors 108 may be built into the camera of Mobile Device 110 or may be a separate, specialized device that is built in separate from the camera.

In one or more embodiments, VLC Stadium Controller 102 provides users with VLC App 144 and VLC Software 146 that can be downloaded to Mobile Device 110 via Communication Network 114. In these embodiments, VLC App 144 is software to be installed in Mobile Device 110 for interacting with VLC Stadium Controller 102. Examples of VLC App 144 are native apps in Android/iOS that have embedded software for the real HTML5 app. VLC Software 146 is software that is resident on VLC Stadium Controller 102 and downloaded and installed on Mobile Device 110 to interact with VLC Stadium Controller 102. Communication Network 114 may be implemented as the Cloud or the Internet, perhaps including a cellular telephone sub-network.

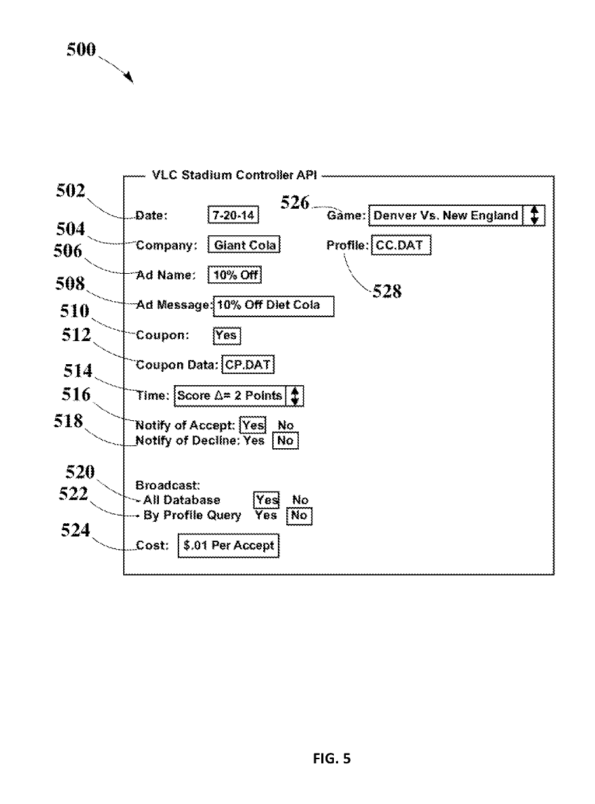

In one or more embodiments, API controller 142 within VLC Stadium Controller 102 is an application programming interface which loads and manages data from the various advertisers and networks for loading into VLC Database 138 for distribution by VLC Stadium Controller 102. In these embodiments, API controller 142 controls and manages other APIs, which are further described in FIG. 5, for advertisers, messages, events, partners, and 3rd parties.

In one or more embodiments, VLC Software (Native) 126 is software that is downloaded from VLC Stadium Controller 102 (e.g., VLC software 146) and installed on Mobile Device 110 to interact with VLC Stadium Controller 102. In these embodiments, VLC Software (Native) 126 is native software embedded on top of OS 134 (Android/iOS) that is always running in the background and is enabled by the user with OS Settings 136. In further embodiments, VLC Software (Native) 126 provides the user 112 of Mobile Device 110 with a code 128 and a Profile DB 130. An example of Code 128 may be an encryption code that varies on a loop over time. An example of Profile DB 130 may be a profile database that stores information related to (e.g., describing) the user 112 and is located in Mobile Device 110.

In exemplary operation, user 112 attaches VLC Detector 108 to Mobile Device 110 and COMM 124 is activated. Examples of COMM 124 include Wi-Fi, 3G, 4G, LTE, and the like. User 112 employs Mobile Device 110 to connect to the VLC Stadium Controller 102 through Communication Network 114 and to download VLC Software 146 and VLC App 144. VLC Software 146 and VLC App 144 are installed in Mobile Device 110, shown as VLC Software 126 and Mobile Device VLC App 132 in FIG. 1. When VLC Software 126 and VLC App 132 begin operation, VLC Software 126 begins monitoring and communicating with VLC Detector 108. VLC Software 126 and VLC App 132 are then defined in VLC App 132, and a profile 130 is loaded or created wherein the user 112 fills in personal data such as, name, emails, phone number, membership status (e.g., gold member of club or credit card) and the like. VLC App 132 also generates an encryption code 128. User 112 sends the profile 130 and the encryption code 128 via Communication Network 114 to VLC Stadium Controller 102, which logs into VLC Stadium Software 140. VLC Stadium Software 140 queries VLC Database 138, specifically the user profile database, to check if the specific person who downloaded VLC App 144 is available, listed, or otherwise represented in the VLC Database 138. If so, VLC Stadium Controller 102 then sends back, via VLC Bulb 106, an encryption or security code with (or without) a message to the specific user 112 associated with Mobile Device 110. VLC Detector 108 attached to Mobile Device 110 detects the light signals from VLC Bulb 106 and passes data representing the signals to the VLC App 132, which whether there is a match between the received security code and the associated profile 130. If so, user 112 receives messages that may or may not include ads, coupons, or general information about the stadium and/or event hall. User 112 may or may not respond to the received message. If user 112 responds, an automatic security code generator built in to VLC App 132 generates a new code 128 that is sent back to VLC Stadium Controller 102 with the response message, thus starting a communication loop.

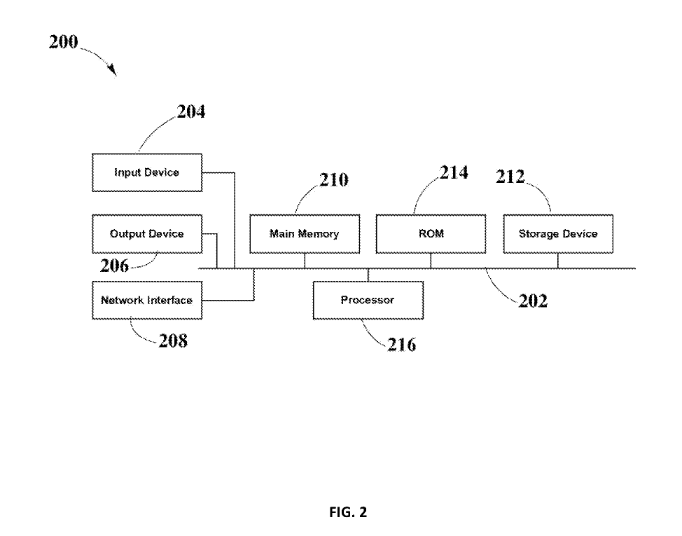

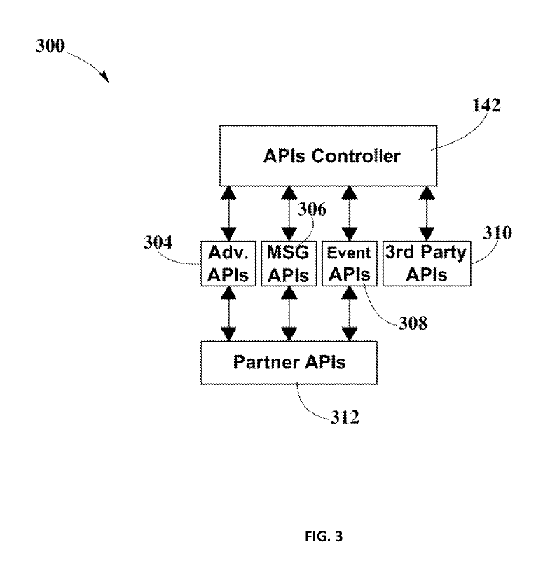

FIG. 2 is a diagram of examples of the components of a computing device 200, which may be a server, according to an exemplary embodiment. In FIG. 2, computing device 200 may be any of several computing devices, such as, servers, laptop computers, desktop computers, tablets, smartphones, and the like that may operate within Broadcast System 100 of FIG. 1, execute modules described in FIG. 3, or execute code implementing concepts/ideas contained in FIGS. 4-10, according to an exemplary embodiment.

According to some aspects of this embodiment, computing device 200 includes a bus 202, an input device 204, an output device 206, a network interface 208, a main memory 210, a storage device 212, a read only memory (ROM 214) and a processor 216. In other exemplary embodiments, computing device 200 (e.g., a server) may include additional, fewer, different, or differently arranged components than are illustrated in FIG. 2.

In one embodiment, bus 202 coordinates the interaction and communication among the components of the computing device 200. Input device 204 includes a mechanism that permits a user to input information to computing device 200, such as a keyboard, a mouse, a button, a pen, a touch screen, voice recognition and/or biometric mechanisms, etc. Output device 206 includes a mechanism that outputs information to the operator, including, for example, a display, a light emitting diode (LED), and a speaker, among others.

Network interface 208 enables computer interactions with other devices and/or systems via a network connection. Network connections may refer to any suitable connection between computers such as intranets, local area networks (LAN), cloud networks, virtual private networks (VPN), wireless area networks (WAN), and the internet, among others.

Main memory 210 may include a random access memory (RAM) or another type of dynamic storage device that may store information and instructions for execution by processor 216. ROM 214 may include a ROM device or another type of static storage device that may store static information and instructions for use by processor 216. Processor 216 may include a microprocessor, an application specific integrated circuit (ASIC), and a field programmable object array (FPOA), among others, that may interpret and execute instructions.

According to some aspects of one embodiment, computing device 200 implemented as a server, using one or more suitable software modules, enables and performs data fetching, biometrics processing tasks, and predictive analytics. The server performs these operations in response to or as implemented by processor 216 executing software instructions contained in a computer-readable medium, such as main memory 210.

The software instructions may be read into main memory 210 from another computer-readable medium, such as storage device 212, or from another device via network interface 208. The software instructions contained in main memory 210 may cause processor 216 to perform processes that will be described later. Alternatively, hardwired circuitry may be used in place of or in combination with software instructions to implement processes described herein. Thus, implementations described herein are not limited to any specific combination of hardware circuitry and software.

FIG. 3 is a block diagram illustrating a portion of the broadcast system 100 pertaining to API Controller 142 within VLC Stadium Controller 102. In FIG. 3, subsystem 300 includes an APIs Controller 142, Advertiser APIs 304, Message APIs 306, Events APIs 308, 3rd Party APIs 310, and Partners APIs 312. It should be understood that subsystem 300 can include fewer components, more components, or different components depending on the desired analysis goals. In an example, APIs Controller 142, Advertiser APIs 304, Message APIs 306, Events APIs 308, 3rd Party APIs 310, and Partners APIs 312 are implemented as the API Controller, Advertisers APIs, Message APIs, Events APIs, 3rd Party APIs and Partners APIs in Broadcast System 100 of FIG. 1. APIs Controller 142 is operatively coupled to and in bi-directional communication with one or more Advertiser APIs 304, one or more Message APIs 306, one or more Events APIs 308, one or more 3rd Party APIs 310, and one or more Partners APIs 312.

In one or more embodiments, APIs Controller 142 is any Representational State Transfer Application Programming Interface (REST API) that controls and manages one or more APIs. In these embodiments, APIs Controller 142 provides web services to one or more mobile applications. Examples of web services include showing data on a website, uploading large amounts of data that will later be consumed in a mobile app, downloading data to run custom analytics, exporting data, and the like.

In one embodiment, Advertiser APIs 304 are APIs that send advertisements to APIs controller 142 that are later distributed by VLC Stadium Controller 102 to not only a target zone within the stadium but also to a specific device(s). In another embodiment, Message APIs 306 are APIs that are used to push any type of data (message) to specific devices or multiple targets. In a further embodiment, Events APIs 308 are APIs used to push notifications about an event within the stadium. In yet a further embodiment, 3rd Party APIs 310 are APIs used from 3rd party providers that wish to use the broadcast system in the stadium. Partners APIs 312 are APIs used to authorize 3rd party providers with access to APIs Controller 142 so as to provide a billing platform to charge a partner per request to the API.

FIG. 4 is a block diagram illustrating a portion of the broadcast system pertaining to the VLC Database 138 within the VLC Stadium Controller 102. In FIG. 4, subsystem 400 includes VLC Database 138, User Profiles Databases 402, Advertisers Databases 404, 3rd Party Network Databases 406, Other Databases 408, and Stadium Databases 410. It should be understood that subsystem 400 can include fewer components, more components, or different components depending on the desired analysis goals. In an example, VLC Database 138, User Profiles Databases 402, Advertisers Databases 404, 3rd Party Network Databases 406, Other Databases 408, and Stadium Databases 410 are implemented as the VLC Database, User Profiles Databases, Advertisers Databases, 3rd Party Network Databases, Other Databases, and Stadium Databases in Broadcast System 100 of FIG. 1. VLC Database 138 is operatively coupled to and in bi-directional communication with User Profiles Databases 402, Advertisers Databases 404, 3rd Party Network Databases 406, Other Databases 408, and Stadium Databases 410.

In one embodiment, VLC Database 138, User Profiles Databases 402, Advertisers Databases 404, 3rd Party Network Databases 406, Other Databases 408, and Stadium Databases 410 are a plurality of relational databases that provide functions of fetching, indexing, and storing data. Examples of data are information related to the users (e.g., user 112) such as personal information, information produced by advertisers to be transmitted to the users (ads, coupons), and general information about events that happen within the stadiums and/or event halls that are VLC transmitted to a target zone or a specific user within the lighted site. VLC Database 138, User Profiles Databases 402, Advertisers Databases 404, 3rd Party Network Databases 406, Other Databases 408, and Stadium Databases 410 may be implemented through known in the art database management systems (DBMS), such as, MySQL, PostgreSQL, SQLite, Microsoft SQL Server, Microsoft Access, Oracle, SAP, dBASE, FoxPro, IBM DB2, LibreOffice Base, FileMaker Pro, and/or any other type of database that may organize collections of data.

FIG. 5 is an exemplary illustration of a user interface 500 of the VLC Stadium Controller API. In FIG. 5, user interface 500 includes one or more fields, such as, for example date 502, company 504, Ad. Name 506, Ad. Message 508, Coupon 510, Coupon Data 512, Time 514, Notify of Accept 516, Notify of Decline 518, Broadcast All Database 520, Broadcast By Profile Query 522, Cost 524, Game 526, and Profile 528. It should be understood that user interface 500 can include fewer fields, more fields, or different fields depending on the desired analysis goals.

In an exemplary embodiment, user interface 500 illustrates a particular API that is controlled by an advertiser that intends to broadcast an advertisement to a target zone or to a specific user(s) in a stadium (or other lighted site or venue) via the exemplary broadcast system previously described in FIG. 1. In this embodiment, the fields include the following exemplary information: date 502 is 7-20-14; Game 526 is Denver versus New England; Company 504 is Coke; Profile 528 is CC.DAT that the company provides; Ad name 506 is ten percent (10%) off; Ad Message 508 is a message that says ten percent off Diet Coke or Coca Cola; coupon 510 is “Yes;” Coupon data 512 is the CP.DAT (e.g., Coupon data 512 could be a QR code); Time 514 is sending the ad when there's a score change (e.g., in the game) of at least two points; Notify of Accept 516 is “Yes;” Notify of Decline 518 is “No;” Broadcast All Database 520 is “Yes;” Broadcast By Profile Query 522 is “No;” and Cost 524 is $0.01 per accept. In this example, the cola company wants to send the advertisement to users that are gold members (target zone) and is waiting for a list of gold members who respond positively to the advertisement.

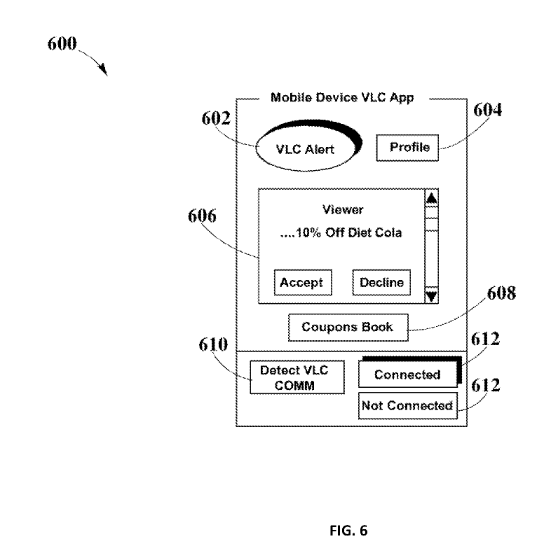

FIG. 6 is an exemplary illustration of a user interface 600 of the VLC App installed on one or more mobile devices (e.g., VLC app 132 of FIG. 1). In FIG. 6, user interface 600 includes one or more fields such as, for example, VLC Alert 602, Profile 604, Message Display Area 606, Coupons Book 608, Detect VLC COMM 610, and Connection Status 612. It should be understood that user interface 600 can include fewer fields, more fields, or different fields depending on the desired goals and functionality.

In the exemplary embodiment shown, user interface 600 illustrates a message (e.g., a coupon) to the user 112 received from the VLC Stadium Controller 102 when VLC Alert 602 button is activated. Profile 604 allows the user to fill in the profile 130. In Message Display Area 606, a message is displayed illustrating an ad that is a coupon of ten percent off Diet Cola. The user accepts or declines the ad using the virtual buttons shown in Message Display Area 606. If the user accepts the ad, the ad goes into Coupons Book 608 for use later. User interface 600 also illustrates a user control 610 that allows the user to attempt to see if there are VLC communications in the nearby area. Connection status 612 illustrates whether the mobile device is connected or not.

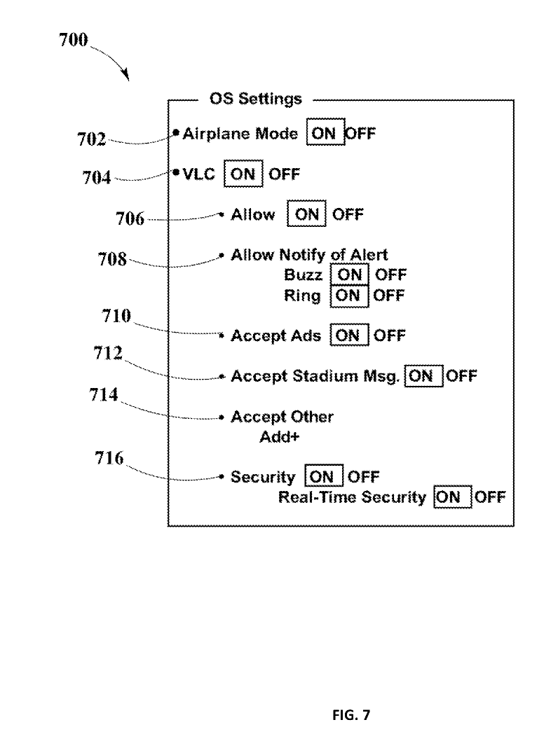

FIG. 7 is an exemplary illustration of a user interface 700 for the OS Settings 136 in one or more mobile devices. In FIG. 7, user interface 700 includes one or more OS settings such as, for example, Airplane Mode 702 and VLC Settings 704. In some embodiments, VLC Settings 704 further includes Allow VLC 706, Allow Notify of Alert 708, Accept Ads 710, Accept Stadium Messages 712, Accept Other 714, and Security 716. It should be understood that user interface 700 can include fewer settings, more settings, or different settings depending on the desired goals and functionality.

In an exemplary embodiment, user interface 700 displays to the user 112 OS settings of the mobile device that can be used to configure the mobile device 110 according to the user's preferences. In this embodiment, the user 112 can set the airplane mode to “on” or “off,” VLC to “on” or “off,” receive notification of an alert by buzzing or ringing, accept ads or do not accept ads, accept stadium messages or do not accept stadium messages, accept other messages or do not accept other messages, set security to “on,” and set real-time security to “on.” In this embodiment, when security is “on” the VLC App generates, for each communication, a new security code 128 based on the profile 130.

### Method for VLC Multi Channel Communications

In some embodiments, one or more methods for VLC multi-channel communications are performed by one or more computing devices, such as computing device 200. The methods are implemented with and by components of the exemplary operating environments of FIGS. 1-7. The steps of this exemplary method may be embodied in a computer readable medium containing computer readable code such that the steps are implemented when the computer readable code is executed by a computing device. While the blocks in the disclosed processes are shown in a particular order, the order may differ in different implementations. In some embodiments, some steps may be performed in parallel.

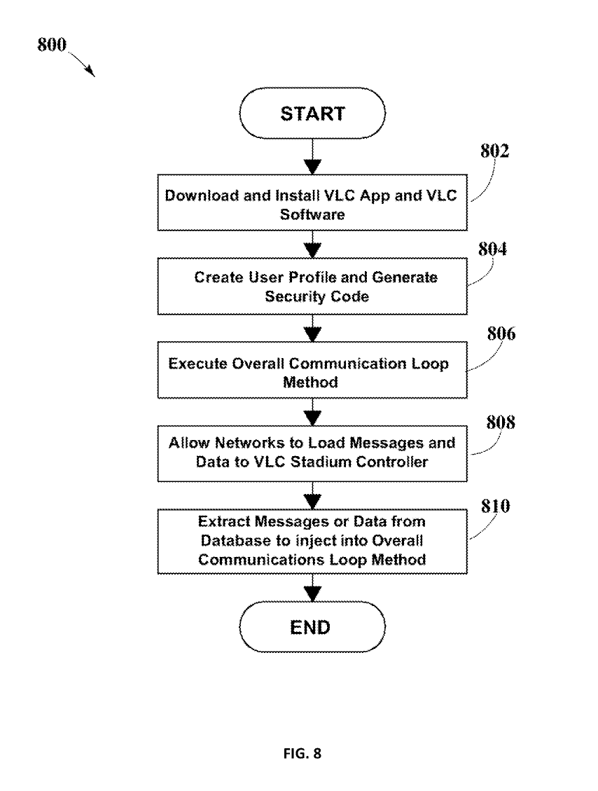

FIG. 8 is a flowchart of an example of a method 800 for a broadcast system using VLC multi-channel communications. In some embodiments, method 800 operates within a broadcast system 100 that is used in a lighted site such as a sports stadium or an event hall. For example, information related to sports, events, or ads may be sent to multiple users via VLC Multi-channel protocol and multiple users may be able to respond to the information.

In one or more embodiments, method 800 begins when a user of a mobile device 110 downloads from the VLC stadium controller 102 a VLC App 144 and VLC software 146 to install the VLC App and VLC software on the mobile device (step 802). In these embodiments, the mobile device uses the COMM 124 (e.g., Wi-Fi, 4G, 3G, LTE) to connect to the VLC Stadium controller 102, via the communications network 114, to download VLC app 144 and VLC software 146. In these embodiments, the VLC app 144 is software to be installed in the mobile device 110 for interacting with the VLC stadium controller 102. Examples of the VLC app 144 are native apps in Android/iOS that have embedded software for the real HTML5 app. The VLC software 146 is software that is resident on the VLC stadium controller 102 and downloaded and installed on the mobile device 110 to interact with the VLC stadium controller 102. The communication network 114 is the Cloud or the Internet. Method 800 then advances to step 804.

At step 804, the user 112 using the VLC app 132 installed on the mobile device 110 creates a user profile 130 and generates a security code 128 that is sent and uploads to the VLC stadium controller 102 through the COMM 124 and via the communications network 114. In one or more embodiments, the user profile 130 includes information about the user 112, such as, name, email, phone number, and the like. In these embodiments, the VLC app 132 includes an automatic security code generator for generating the security code 128. Method 800 then advances to step 806.

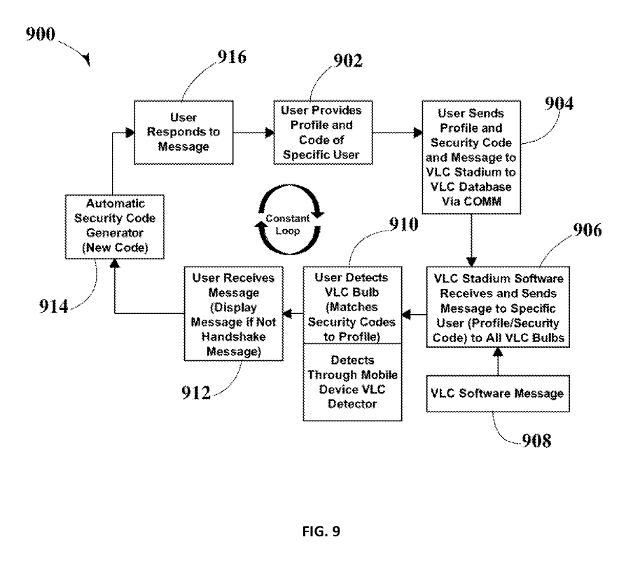

At step 806, after receiving user profiles and security codes, the VLC stadium controller 102 executes the overall communications loop method between the user device 110 and the VLC stadium controller 102, utilizing the VLC detector 108, a light source such as the VLC bulbs 106, and the hardwire connector 104 to communicate to the mobile device 110, and utilizing the communication network 114, and COMM 124 to receive communications from the mobile device 110. The modules contained/operating within the overall communications loop method are further detailed in FIG. 9. Method 800 then advances to step 808.

At step 808, the VLC stadium controller 102 allows the advertiser network 119, the 3rd party network 120, and/or other networks 122 to load messages and data through the APIs controller 142 of the VLC stadium controller 102 into the VLC database 138 for further distribution via VLC. In one or more embodiments, the APIs controller 142 of the VLC stadium network is an application programming interface which loads, manages, and controls the communication with the APIs for messages, advertisers, events, 3rd parties, and partners. Examples of messages and data include advertisements, messages including any type of data, notifications about an event within the stadium, and the like. Method 800 then advances to step 810.

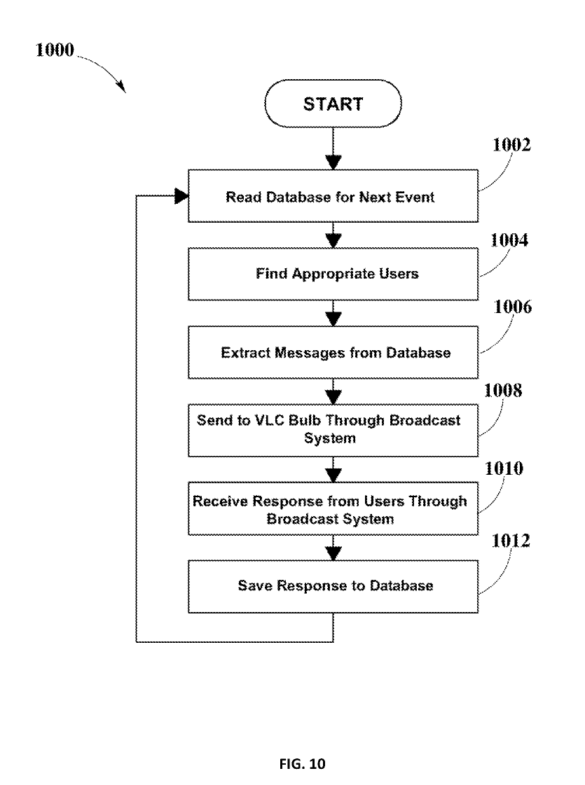

At step 810, after loading messages and data from the advertiser network 118, the 3rd party network 120, and other networks 122 into the VLC database 138, the VLC stadium controller 102 executes the VLC stadium software 140 to extract messages and data from the VLC database 138 to inject into the overall communications loop method. The method for extracting messages and data from the VLC database 138 is further described in FIG. 10.

FIG. 9 is a flowchart illustrating an example of an overall communications loop method 900 within a broadcast system using VLC multi-channel communications. In some embodiments, method 900 operates within a broadcast system 100 that is used in a sport stadium, an event hall, or other site that contains a large number of people and includes lights suitable for VLC. For example, information related to sports, events, or ads is sent to multiple users via VLC Multi-channel and the multiple users may be able to respond to that information.

In one or more embodiments, method 900 begins when a user 112 of a mobile device 110, which has previously downloaded and installed a VLC app 132 and VLC software 126, provides information to create and/or populate a profile 130. The user 112 may also provide an initial code 128 corresponding to the specific user 112 to the VLC App 132 (step 902). In these embodiments, the user profile 130 includes information about the user 112 such as name, email, phone number, and the like. In some embodiments, the VLC app 132 may include an automatic security code generator for generating the security code 128, so the user 112 need not provide one. Method 900 then advances to step 904.

At step 904, the user 112 of the mobile device 110 (e.g., by operating the VLC App 132) sends the profile 130, the security code 128, and optionally a message or other data to the VLC database 138 resident within the VLC stadium controller 102 using the mobile device COMM 124 and via the communication network 114 connected to the VLC stadium controller 102. Method 900 then advances to step 906.

At step 906, the VLC stadium controller 102, or more specifically, the VLC stadium software 140 receives the user profile 130 and the security code 128, which then are matched in the VLC database 138, for example, to identify a specific user having information stored in the database. The VLC stadium controller 102 then sends a message back to the specific user using the profile 130 and the security code 128 to identify the specific user. In some embodiments, the VLC stadium controller 102 uses a light source, e.g., VLC bulbs 106, to send the message and the security code 128 to the user 112. In these embodiments, a VLC software message 908 is injected into the VLC stadium controller 102. Examples of VLC software message 908 include messages and data from the VLC database 138 that are loaded from the advertisers' network 118, the 3rd party network 120, and/or the other networks 122. Method 900 then advances to step 910.

At step 910, the mobile device 110, using the VLC detector 108 attached to it, detects, reads, and converts the light signal from the VLC bulbs 106, and matches the security code within the signal to the profile 130, e.g., to determine whether the signal is directed to or meant for the user 112. In some embodiments, the VLC software (Native) 126 running in the background of the mobile device 110 monitors the VLC detector 108 to check for incoming messages from the VLC stadium controller 102. Method 900 then advances to step 912.

At step 912, the user 112 receives the message through the VLC app 132 previously installed on the mobile device 110. In one or more embodiments, the user interface of the VLC App 132 may show ad information including coupons, for example as previously described with respect to FIG. 6. In various embodiments, the VLC stadium controller 102 may send a handshake message that is not displayed to the user 112 and that is useful for establishing a communication loop between the VLC stadium controller 102 and the mobile device 110. Method 900 then advances to step 914.

At step 914, an automatic security code generator built in the VLC app 132 and previously installed on the mobile device 110 generates a new security code 128. Examples of security codes include encryption codes that can be randomly generated with any code generator and are constantly updated during each process loop. Method 900 then advances to step 916.

At step 916, the user 112 responds to the message from VLC stadium controller 102. In one or more embodiments, the user 112 may or may not respond to ads, messages, or events distributed within the broadcast system 100. If the user 112 responds, the mobile device 110 the COMM 124 and via the communication network 114 sends back an acknowledgement message and a new security code 128 to the VLC stadium controller 102. Method 900 then returns to step 902 or 904 unless or until the user 112 decides to end VLC communication with the mobile device 110 by turning off the VLC option in the OS settings 136, for example as described in FIG. 7.

FIG. 10 is a flowchart illustrating an example of a method for extracting messages and data from the VLC Database 138 within the VLC stadium controller 102. In some embodiments, method 1000 operates within a broadcast system 100 that is used in a sport stadium or an event hall or the like. For example, information related to sports, events, or ads relevant to the site or venue can be sent to multiple users via VLC Multi-channel protocol, and multiple users may be able to respond to the received information.

In one or more embodiments, method 1000 begins when the VLC software 140, resident in the VLC stadium controller 102, reads the VLC database 138 for the next event (step 1002). In these embodiments, an event is any message or data that has been previously stored in the VLC database 138 by, for example, the advertiser network 118, a 3rd party network 120, and/or other networks 122 for distribution via VLC. Method 1000 then advances to step 1004.

At step 1004, the VLC software 140 resident in the VLC stadium controller 102 finds appropriate users to receive the event in a user profiles' database 404 that is part of the VLC database 138. In one or more embodiments, appropriate users refer to users that have already enabled their mobile devices 110 for VLC communication to receive ads, coupons, messages, events, and the like. In various embodiments, appropriate users refer to users having profile information that corresponds to a specified, desired attribute(s), such as being a gold member of a club, being within a certain age range, living within a certain geographic area based on ZIPCode or telephone area code, being a season ticket holder, or the like. Method 1000 then advances to step 1006.

At step 1006, the VLC software 140 extracts messages from the VLC database 138. In one or more embodiments, the VLC software 140 queries different databases according to the event subject matter. For example, the VLC software 140 queries the advertisers' database 404 if the next event is related to an ad, such as sending coupons to one or more appropriate users. Method 1000 then advances to step 1008.

At step 1008, the VLC stadium controller 102 sends messages to a light source, such as all of the VLC bulbs 106, through the broadcast system 100. VLC bulbs 106 send a light communication signal including the messages to all active VLC detectors 108 attached to mobile devices 110 at the venue or other site. In one or more embodiments, the VLC controller 102 sends messages to appropriate users 112 that are connected to the broadcast system 100. Method 1000 then advances to step 1010.

At step 1010, the VLC stadium controller 102 receives responses from users 112. In one or more embodiments, the users 112 send a response to the VLC stadium controller 102 through the COMM 124 and via the communication network 114. In an example, the users 112 send a response to the VLC stadium controller 102 using Wi-Fi, 3G, 4G, LTE, or the like. Method 1000 then advances to step 1012.

At step 1012, the VLC software 140 saves user responses to the VLC database 138. In one or more embodiments, when the user 112 acknowledges receipt of the message, the VLC app 132 sends the user response to the VLC stadium controller 102 and the message automatically appears on the user interface of the VLC app 132. Method 1000 then returns to step 1002.

### EXAMPLE

This example refers to a Broadcast System deployment within a sports stadium. The Broadcast System 100 includes all the components described in FIG. 1. In this example, the Broadcast System is configured to inform one or more users, via their mobile devices about new products for baseball fans in attendance at the game. The new products include jerseys, caps, baseball posters, and the like. The information about the new products is sent to selected users (e.g., gold card holders) within a selected zone within the stadium via VLC bulbs, such as LEDs and the like, so only users having a gold card membership would receive said information.

The users, using their VLC-enabled mobile devices, receive the information through a user interface, such as the one described in FIG. 6. The received information includes virtual coupons that will give the user(s) a 40% discount off of any purchase, but only if the user(s) replies immediately to the offer. In this example, most of the gold members accept the offer using their mobile devices and the offer is immediately saved in the coupon book associated with the VLC App running on the mobile device (for example, as described in FIG. 6). Approximately simultaneously (e.g., triggered by the acceptance of the offer), the user's mobile device sends a message to the VLC Stadium Controller via the Communication Network (e.g., Wi-Fi, 3G, 4G, LTE, and the like).

The coupon book can then be accessed by the user using the mobile device and the VLC App whenever the user wants to use the coupon.

The foregoing system and method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless receiver or mobile device, such as a smartphone or tablet computer. Such circuitry may include circuits for accomplishing the receiving, calculating, matching, transmitting, etc. steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method, implemented by a computing device, for communicating with a mobile device associated with a user in a site, the method comprising:
selecting, by the computing device, a message for broadcasting;
selecting, by the computing device, the user as being appropriate to receive the message;
broadcasting the message with information identifying the user, wherein the computing device controls light sources in the site containing the mobile device associated with the user to perform the broadcasting;
receiving, by the computing device, a response to the message from the mobile device associated with the user, wherein the response is transmitted via a radio frequency signal from the mobile device; and
storing, by the computing device, the response in association with the user.

2. The method of claim 1, further comprising:
receiving a user profile from the user; and
wherein selecting the user as being appropriate to receive the message comprises:
selecting the user based on information in the user profile that indicates the user possesses a desired attribute.

3. The method of claim 1, further comprising:
receiving a security code from the user; and
wherein broadcasting the message with information identifying the user comprises:
broadcasting the message with the security code that was received from the user.

4. The method of claim 1, wherein receiving a response to the message from the mobile device associated with the user comprises:
receiving a newly generated security code from the mobile device associated with the user; and
wherein storing the response in association with the user comprises:
storing the newly generated security code

5. The method of claim 4, further comprising:
broadcasting a second message with the newly generated security code to the user.

6. The method of claim 1, wherein the message comprises one of a group consisting of: an ad; a coupon, directions, information regarding the site, and information regarding an event in the site.

7. The method of claim 1, further comprising:
receiving the message from an entity that advertises in the site; and
storing the message for later selection for broadcasting in the site.

8. The method of claim 7, wherein receiving the message comprises:
receiving the message via an application programming interface (API) of the computing device, wherein the entity that advertises in the site uses the API to provide the message.

9. A system for communicating with a mobile device associated with a user in a site, the system comprising:
a computing device;
a light source in the site, operably connected to the computing device, wherein the computing device causes the light source to generate visible light communication signals representing a message;
a connection to a communication network that receives radio frequency signals from the mobile device;
wherein the computing device performs operations comprising:
selecting the message for broadcasting;
selecting the user as being appropriate to receive the message;
broadcasting the message with information identifying the user via the light source in the site;
receiving, via the connection to the communication network, a response to the message from the mobile device associated with the user, wherein the response is transmitted via a radio frequency signal from the mobile device; and
storing the response in association with the user.

10. The system of claim 9, wherein the operations further comprise:
receiving, via the connection to the communication network, a user profile from the user; and
wherein selecting the user as being appropriate to receive the message comprises:
selecting the user based on information in the user profile that indicates the user possesses a desired attribute.

11. The system of claim 9, wherein the operations further comprise:
receiving, via the connection to the communication network, a security code from the user; and
wherein broadcasting the message with information identifying the user comprises:
broadcasting the message with the security code that was received from the user.

12. The system of claim 9, wherein receiving a response to the message from the mobile device associated with the user comprises:
receiving, via the connection to the communication network, a newly generated security code from the mobile device associated with the user; and
wherein storing the response in association with the user comprises:
storing the newly generated security code

13. The system of claim 12, further comprising:
broadcasting a second message with the newly generated security code to the user.

14. The system of claim 9, wherein the message comprises one of a group consisting of: an ad; a coupon, directions, information regarding the site, and information regarding an event in the site.

15. The system of claim 9, wherein the operations further comprise:
receiving, via the connection to the communication network, the message from an entity that advertises in the site; and
storing the message for later selection for broadcasting in the site.

16. The system of claim 15, wherein receiving the message comprises:
receiving the message via an application programming interface (API) of the computing device, wherein the entity that advertises in the site uses the API to provide the message.

17. A non-transitory computer-readable media containing instructions for communicating with a mobile device associated with a user in a site that, when executed by a processor, perform a method comprising:
selecting a message for broadcasting;
selecting the user as being appropriate to receive the message;
broadcasting the message with information identifying the user, wherein the processor controls light sources in the site containing the mobile device associated with the user to perform the broadcasting;
receiving a response to the message from the mobile device associated with the user, wherein the response is transmitted via a radio frequency signal from the mobile device; and
storing the response in association with the user.

18. The non-transitory computer-readable media of claim 17, wherein the method further comprises:
receiving a user profile from the user; and
wherein selecting the user as being appropriate to receive the message comprises:
selecting the user based on information in the user profile that indicates the user possesses a desired attribute.

19. The non-transitory computer-readable media of claim 17, wherein the method further comprises:
receiving a security code from the user; and
wherein broadcasting the message with information identifying the user comprises:
broadcasting the message with the security code that was received from the user.

20. The non-transitory computer-readable media of claim 17, wherein receiving a response to the message from the mobile device associated with the user comprises:
receiving a newly generated security code from the mobile device associated with the user; and
wherein storing the response in association with the user comprises:
storing the newly generated security code

21. The non-transitory computer-readable media of claim 20, wherein the method further comprises:
broadcasting a second message with the newly generated security code to the user.
